(19) United States
(12) Patent Application Publication
(10) Pub. No.: US 2005/0016667 A1
(43) Pub. Date: Jan. 27, 2005

(54) Method of manufacturing lampshades

(76) Inventors: Mark Dwight, Palo Alto, CA (US); Geoff Sacco, Sausalito, CA (US)

Correspondence Address: BURNS, DOANE, SWECKER & MATHIS, L.L.P., P.O. Box 1404, Alexandria, VA, 22313-1404, US

(21) Appl. No.: 10/624,569

(22) Filed: Jul. 23, 2003

(51) Int. Cl. B32B 31/00

(52) U.S. Cl. 156/218; 156/277

(57) ABSTRACT

A method of manufacturing lampshades, including: having a plurality of end-users each select a graphical design for a lampshade; printing a plurality of selected graphical designs together on a single substrate; cutting out individual sections of the substrate, the sections corresponding to the selected graphical designs; and forming a lampshade from each of the individual cut out sections of the substrate.

### TECHNICAL FIELD

The present invention relates to a system for manufacturing lampshades.

### BACKGROUND OF THE INVENTION

Lamps and lampshades come in an exceptionally large number of designs (i.e. various sizes, shapes, colors and models). As such, they are essentially a “fashion” item that requires purchasers to spend time looking at a number of different designs side-by-side before actually selecting and then purchasing an appropriate lamp/lampshade. As a result, lamp/lampshade retail stores typically need to display a showroom full of lamps and lampshades side-by-side so that end-users are able to pick out a model to his or her liking.

Unfortunately, this system of choosing lamps and lampshades requires that a large number of lampshades be kept in inventory in lighting and various home accessory stores. This, in turn, requires considerable floor space for the lamp/lampshade showroom. In addition, such retail stores must cover the costs of stocking their shelves with a range of lamps and lampshade models for prolonged periods of time. The store's costs of keeping a large inventory of lamps and lampshades on hand is then, of course, passed onto the end-user purchasers.

### SUMMARY OF THE INVENTION

The present invention provides a method of manufacturing lampshades, comprising: having a plurality of end-users each select a graphical design for their own particular lampshade; printing a plurality of the selected graphical designs together on a single substrate; cutting out individual sections of the substrate, wherein these sections correspond to the selected graphical designs; and then forming lampshades from the individual cut out sections of the substrate.

In various preferred aspects of the method, each end-user selects a graphical design from a menu of graphical designs displayed on a computer screen. Preferably, such selection may be made over the Internet. In addition, the end-user may optionally upload and modify their own particular selected graphical designs.

An advantage of the present method is that the graphical designs which comprise the individual lampshades are printed after they have been selected by the individual end-users. Thus, each individual end-user (i.e. each purchaser) selects their own particular lampshade design prior to the lampshades actually being made (i.e.: being printed and formed) for a number of different end-users.

Therefore, an advantage of the present method is that it completely avoids the need to maintain a large inventory of previously made lampshades in stock, just sitting on shelves in a retail store. Instead, the individual users actively select the individual lampshade that is best for them prior to purchasing the lampshades, ensuring that each every lampshade that is made has a purchaser. Thus, the present invention avoids the problem of shelves filled with unsold lamp shades.

In optional aspects of the method, the degree of light transmission through the substrate may also be selected when selecting the individual graphical designs. Such selection of light transmission properties may be made either by selection of the particular graphical design itself, selection of the material itself, selection of the thickness of the material on which the graphical design is printed, or any combination thereof.

In preferred aspects, the substrate onto which the graphical designs are printed is vinyl, and is preferably laminated prior to cutting out and forming the individual lampshades.

Another advantage of the present invention is that the plurality of selected pre-selected graphical designs (which are later cut out to form the individual lampshades) are printed together on a single substrate. Thus, print jobs may be queued so that a number of different lampshades can be printed together on the single substrate at selected intervals of time. This further increases the efficiencies of the present method since a number of different lampshades can be made together in a single production run (with each lampshade design being individually pre-selected by a different purchaser). In preferred aspects of the method, each of the graphical designs are printed together with a unique customer identifier. Preferably, as well, the end-users (i.e.: the lampshade purchasers) pre-pay for their lampshades prior to the lampshades even being made.

In preferred aspects, each of the plurality of end-users also select a shape for their lampshade, and the individual sections of the substrate are then cut out in shapes corresponding to the selected shapes of the individual lampshades. For example, at least one of the shapes may optionally be rectangular, thereby forming a cylindrical lampshade; and/or at least one of the shapes may optionally be C-shaped, thereby forming a truncated conical-shaped lampshade.

In preferred aspects, the lampshades are shipped to the end-users after they have been formed. They may instead be provided to the end-users by other means (such as having the end-users drop by a centralized location to pick them up).

### BRIEF DESCRIPTION OF THE DRAWINGS

FIG. 1 is an illustration of the method of the present invention.

FIG. 2 is a top plan view of a substrate with a plurality of user-selected images printed thereon.

FIG. 3A is a perspective view of a rectangular lampshade.

FIG. 3B is a perspective view of a truncated conical-shaped lampshade.

### DETAILED DESCRIPTION OF THE DRAWINGS

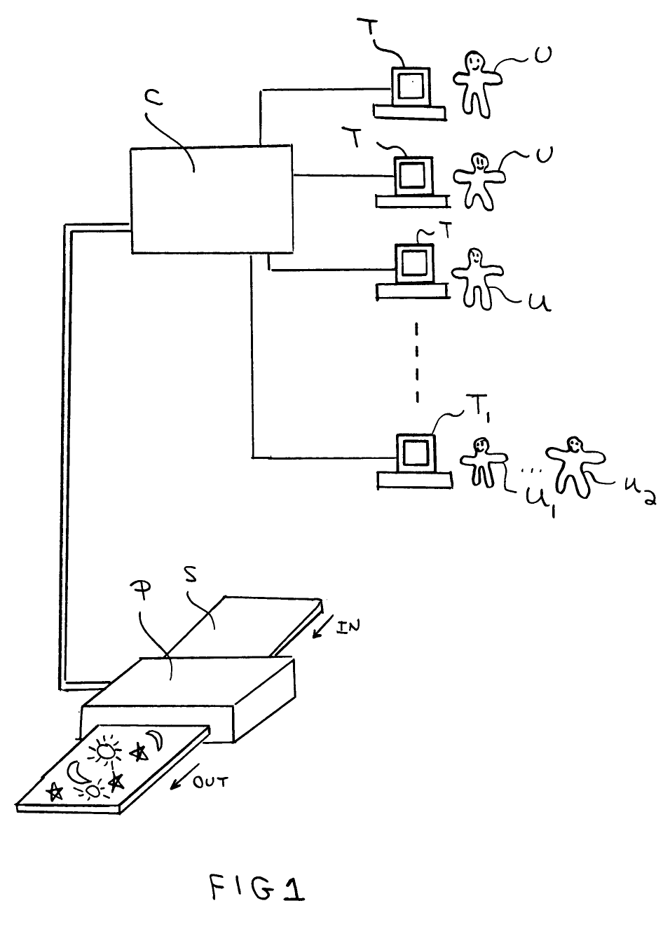

FIG. 1 illustrates the method of the present invention, as follows. The method comprises first having a plurality of end-users U each select a graphical design for their own particular lampshade. As shown, each user U may use a separate computer terminal T to make such selection. However, the number of users U may exceed the number of terminals T such that individual users U₁ and U₂ instead use the same terminal T₁ one after another. In accordance with the present invention, any number of terminals T may be used (including one terminal). The individual terminals T may be linked to a computer C by land lines, phone lines, over the internet, through a wireless network or through any other communication systems.

Typically, each user U is presented with an on-screen menu of lampshade design selections at terminals T from which to choose their own particular lampshades. Computer C then coordinates and records the individual lampshade design selections made by each of the plurality of end-users U. Such information is then passed to printer P which then prints the selected designs, as will be explained. Computer C may be linked to printer P by land lines, phone lines, over the internet, through a wireless network, or through any other communication systems.

Printer P then prints a plurality of selected graphical designs together on a single substrate S. As can be seen, substrate S is initially blank when entering printer P and has designs printed on when exiting printer P. In preferred embodiments, substrate S is vinyl. In preferred embodiments, substrate S may be laminated.

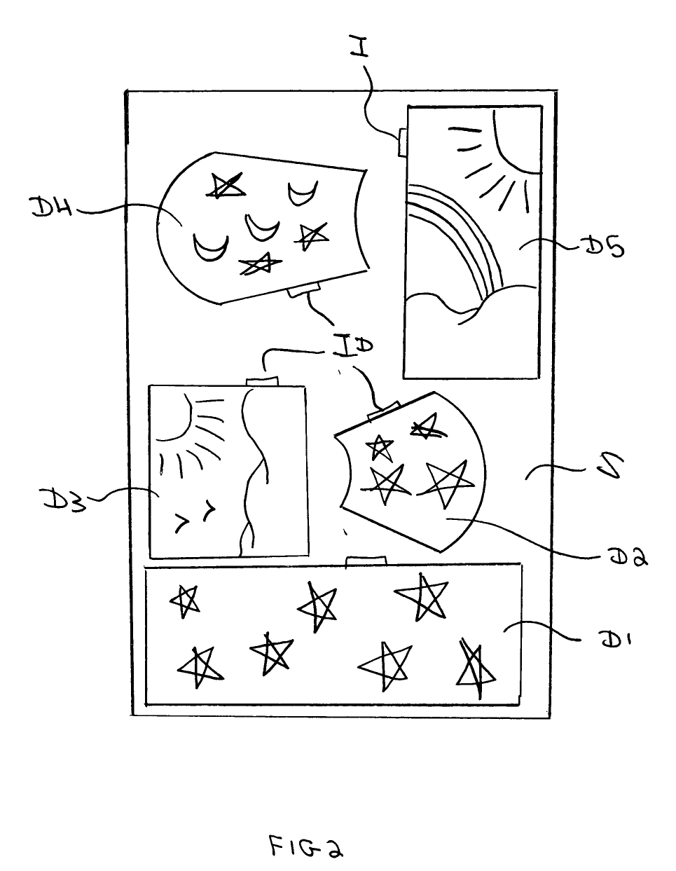

FIG. 2 illustrates substrate S after it has been printed with graphic designs D selected by the various users U. Specifically, a plurality of selected graphical designs D1, D2, D3, D4 and D5 have been printed on substrate S. After printing, each graphical design D is cut out and formed into a lampshade.

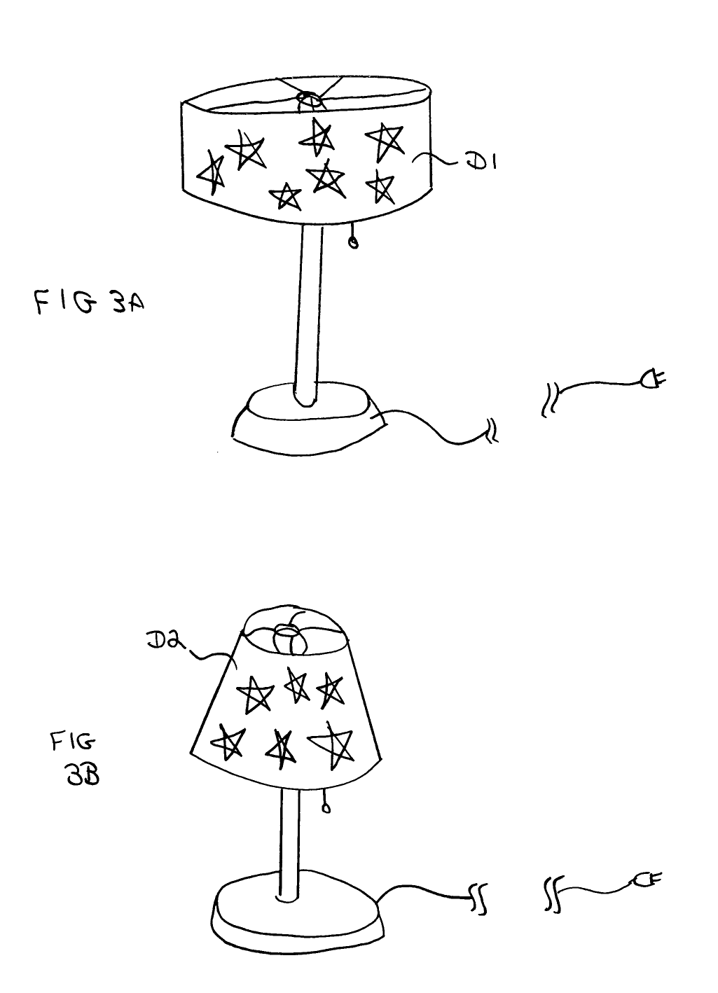

In preferred aspects, each of the plurality of end-users U also selects a shape for their lampshade. As such, graphical designs D are then cut into sections that correspond to the selected shape of the lampshade. For example, graphical designs D1, D3 and D5 are rectangular shaped sections. Therefore, after they have been cut out, they will be generally cylindrical shape, forming a lampshade of the shape shown in FIG. 3A. In contrast, graphical designs D2 and D4 are C-shaped sections (or arcuate portions of a C-shaped section, as shown). Therefore, after they have been cut out, they will form a truncated, generally conical-shaped lampshade of the shape shown in FIG. 3B.

It is to be understood that the borders of the various graphical designs D need not correspond identically to the locations where these designs D are cut out to form lampshades, as is shown for clarity of illustration in FIG. 2. Instead, for example, should a number of different users U all select the same graphical designs D, a large portion of the surface of substrate S can be printed with the selected design D, with different sections of substrate S being cut out (e.g.: in rectangular and C-shaped sections).

In optional aspects, graphical designs D1, D2, D3, D4 and D5 maybe printed with a unique customer identification ID printed thereon. Such customer identification ID would correspond to the individual user U that initially selected (i.e.: ordered) the lampshade, thus helping to keep straight the various lampshade orders. Alternatively, customer identification ID could correspond to a retail store or distribution center from which a number of lampshades have been ordered, or are to be shipped.

In preferred aspects, a plurality of graphical designs D are printed together in batches on individual sheets of substrate S at pre-selected intervals of time, thereby increasing efficiencies and minimizing waste of substrate S material.

In accordance with the present invention, forming a lampshade from each of the individual cut out sections of substrate S may simply involve wrapping the sections such that opposite ends touch one another.

In optional aspects, users U may also select the degree of light transmission through the substrate S. Such selection can be made by selecting the graphical design D itself, selecting the material used for substrate S, or by selecting the thickness of substrate S.

1. A method of manufacturing lampshades, comprising:
having a plurality of end-users each select a graphical design for a lampshade;
printing a plurality of the selected graphical designs together on a single substrate;
cutting out individual sections of the substrate, wherein the sections correspond to the selected graphical designs; and
forming lampshades from the individual cut out sections of the substrate.

2. The method of claim 1, wherein each-end-user selects the graphical design from a menu of graphical designs.

3. The method of claim 2, wherein the menu is displayed on a computer screen.

4. The method of claim 3, wherein the graphical designs are selected over the Internet.

5. The method of claim 1, wherein the substrate is vinyl.

6. The method of claim 1, further comprising:
laminating the substrate prior to forming the lampshades.

7. The method of claim 1, wherein each of the graphical designs are printed together with a unique customer identifier.

8. The method of claim 7, wherein each unique customer identifier corresponds to one of the plurality of end-users.

9. The method of claim 1, further comprising:
having each of the plurality of end-users select a shape for the lampshade; and
cutting out the individual sections of the substrate in shapes corresponding to the selected shapes of the lampshades.

10. The method of claim 9, wherein at least one of the shapes is rectangular, thereby forming a cylindrical lampshade.

11. The method of claim 9, wherein at least one of the shapes is C-shaped, thereby forming a truncated conical-shaped lampshade.

12. The method of claim 1, wherein the graphical designs are printed after they have been selected by the end-users.

13. The method of claim 1, wherein a degree of light transmission through the substrate is selected when selecting the graphical design.

14. The method of claim 1, wherein the graphical designs are printed on the single substrate at selected intervals of time.

15. The method of claim 2, further comprising:
having the end-users individually upload and modify the graphical designs.

16. The method of claim 1, further comprising:
providing the lampshades to the end-users.

17. The method of claim 16, wherein providing the lampshades to the end-users comprises:
shipping the lampshades to the end-users.
